(19) United States
(12) Patent Application Publication
(10) Pub. No.: US 2007/0260280 A1
(43) Pub. Date: Nov. 8, 2007

(54) GEMSTONE DISPLAY PACIFIER

(75) Inventors: Steven B. Dunn, Beverly Hills, CA (US); Mark Hatherill, Manhattan Beach, CA (US); Sean Scott, Woodland Hills, CA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: Munchkin, Inc., North Hills, CA (US)

(21) Appl. No.: 11/382,082

(22) Filed: May 8, 2006

(51) Int. Cl. A61J 17/00

(52) U.S. Cl. 606/234

(57) ABSTRACT

A pacifier assembly includes a teat holder component having a teat connector on a first side thereof and a display face on a second side thereof. A soft elastomeric pacifier teat is preferably securely mounted to the teat connector. A plurality of gemstones is mounted to the display face, preferably in an aesthetically pleasing decorative pattern. Glitter material may be added to the decorative pattern in order to enhance the decorative effect. The pacifier further includes a mouth plate and a protective cover. The protective cover is preferably mounted to the teat holder so as to prevent infants, small children and consumers from touching for gemstones. The protective cover is further preferably constructed so that the gemstones may be visible to infants, small children and consumers therethrough.

### BACKGROUND OF THE INVENTION

1. Field of the Invention

This invention relates generally to the field of infant feeding and care products, and more specifically to infant pacifiers.

2. Description of the Related Technology

A pacifier is a soft, elastomeric rubber or plastic nipple with a retainer that is designed to be given to an infant or small child to suck upon. A pacifier is alternatively sometimes termed a “dummy” (mainly in the UK) or a “soother” (mainly in Canada).

The first mention of pacifiers in western medical literature was circa 1500 in Germany, but similar 2000-3000 year-old specimens have been excavated from graves in Italy and Cyprus by archeologists. These include small clay horses and frogs that possessed handles and were evidently meant to be hung around the neck. One opening permitted the insertion of some viscous material, perhaps honey, while small orifices at the animal's mouth permitted the infant to suck out the honey. Such feeding pacifiers were made in Europe until the Middle Ages. Pieces of fabric with foodstuffs tied inside were also given to babies in many parts of Northern Europe. In some places a piece of meat or fat was tied in cloth, and sometimes the fabric was moistened with brandy. German-speaking areas might use Lutschbeutel, which was a cloth wrapped around sweetened bread, sometimes containing poppy seeds. A pacifier popular in 19^{th} century America was the “sugar teat.” This was made by tying cloth or gauze around a small amount of sugar and soaking it, then giving it to baby to suck. Hard teething articles such as teething rings have also been in use for hundreds of years.

Modern pacifiers were a follow-on development of both hard teething rings and the earlier pacifiers discussed above. The first recognizable modern pacifier is thought to be the “baby comforter” invented by C. W. Meinecke, U.S. Design Pat. No. D33,212.

The use of expensive materials for infant products is not a new concept. Silver teethers and pacifiers were often given to babies born to wealth in earlier centuries. Coral was believed to guard against all kinds of evil and according to the Oxford English Dictionary, in England in the 17th-19th centuries, a coral meant a teething toy made of coral, ivory or bone.

Very recently, pacifiers have appeared on the market that have components that are studded with gemstones. Although these products may be commercially attractive to some consumers, they are potentially unsafe for a number of reasons. The gemstones can become detached from the pacifier, particularly if they are touched by the infant or someone else, and can potentially be aspirated or swallowed by the infant. The risk of the gemstones becoming detached is exacerbated through extended use of the pacifier, and particularly by washing and drying of the pacifier using a dishwasher. In addition, the mounting of the gemstones to the pacifier in such products typically creates small crevices in which bioactive material such as saliva and bits of dried milk and food can collect, meaning that potentially unhealthy bacteria would be expected to propagate on the surface of the pacifier. This will pose a health risk to the infant. Finally, from a purely aesthetic standpoint, exposure of the gemstones to dirt, wax and grease will tend to dull the brightness of the gemstones over time.

A need exists for a gemstone display pacifier that is safer, more sanitary, more durable, and that retains its beauty for a longer period of time than the gemstone pacifiers that have very recently appeared on the market.

### SUMMARY OF THE INVENTION

Accordingly, it is an object of the invention to provide a gemstone display pacifier that is safer, more sanitary, more durable, and that retains its beauty for a longer period of time than the gemstone pacifiers that have very recently appeared on the market.

In order to achieve the above and other objects of the invention, a pacifier according to a first aspect of the invention includes a teat, a main body assembly secured to the teat, a plurality of gemstones, and a protective cover, the protective cover being mounted to the main body assembly so as to prevent infants, small children and consumers from touching the gemstones, the protective cover further being constructed and the gemstones being positioned so that the gemstones may be visible to infants, small children and consumers through the protective cover.

A pacifier component according to a second aspect of the invention includes a teat connector that is constructed and arranged to have an elastomeric teat mounted thereto, and a display face, the display face having a plurality of cavities defined therein, each of the cavities being sized and shaped to receive an individual gemstone for seating therein.

A pacifier display assembly according to a third aspect of the invention includes a display face having a plurality of cavities defined therein, each of the cavities being sized and shaped to receive an individual gemstone for seating therein, the display face further being adapted for connection to a main body assembly of a pacifier; a plurality of gemstones, each of said gemstones respectively being seated in one of said cavities; and a protective cover that is constructed and arranged to prevent infants, small children and consumers from touching said gemstones while permitting said gemstones to be viewed therethrough.

According to a fourth aspect of the invention, a pacifier includes a teat holder having a teat connector on a first side thereof and a display face on a second side thereof, a teat securely mounted to the teat connector, a plurality of gemstones mounted to the display face, a mouth plate, and a protective cover, the protective cover being mounted to the teat holder so as to prevent infants, small children and consumers from touching the gemstones, the protective cover further being constructed so that the gemstones may be visible to infants, small children and consumers therethrough.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is an exploded perspective view of a pacifier that is constructed according to a preferred embodiment of the invention;

FIG. 2 is an isometric cross-sectional view of a pacifier that is constructed according to the embodiment of FIG. 1;

FIG. 3 is a side elevational view of a pacifier constructed according to the preferred embodiment of the invention shown having a first exemplary gemstone design;

FIG. 4 is a side elevational view of a pacifier constructed according to the preferred embodiment of the invention shown having a second exemplary gemstone design;

FIG. 5 is a side elevational view of a pacifier constructed according to the invention shown having a third exemplary gemstone design;

FIG. 6 is a side elevational view of a pacifier constructed according to the preferred embodiment of the invention shown having a fourth exemplary gemstone design;

FIG. 7 is a side elevational view of a pacifier constructed according to the preferred embodiment of the invention shown having a fifth exemplary gemstone design;

FIG. 8 is a side elevational view of the pacifier constructed according to the preferred embodiment of the invention shown having a sixth exemplary gemstone design;

FIG. 9 is a side elevational view of the pacifier constructed according to the preferred embodiment of the invention shown having a seventh exemplary gemstone design;

FIG. 10 is a side elevational view of a pacifier constructed according to the preferred embodiment of the invention shown having an eighth exemplary gemstone design;

FIG. 11 is a side elevational view of a pacifier constructed according to the preferred embodiment of the invention shown having a ninth exemplary gemstone design;

FIG. 12 is a side elevational view of a pacifier constructed according to the preferred embodiment of the invention shown having a tenth exemplary gemstone design;

FIG. 13 is a side elevational view of a pacifier constructed according to the preferred embodiment of the invention shown having an eleventh exemplary gemstone design;

FIG. 14 is a perspective view of a retail packaging unit for distributing and marketing a pacifier according to the preferred embodiment of the invention;

FIG. 15 is a perspective view of a pacifier assembly constructed according to a preferred embodiment of the invention shown having an attaching clip and a connecting leash;

FIG. 16 is a perspective view of a bottom portion of the attaching clip that is depicted in FIG. 15;

FIG. 17 is a side elevational view of a pacifier constructed according to the preferred embodiment of the invention shown having a twelfth exemplary gemstone design; and

FIG. 18 is a side elevational view of a pacifier constructed according to the preferred embodiment of the invention shown having a thirteenth exemplary gemstone design.

### DETAILED DESCRIPTION OF THE PREFERRED EMBODIMENT(S)

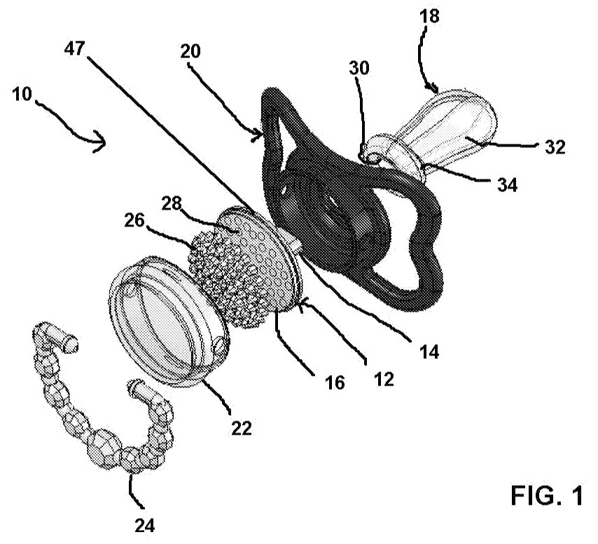

Referring now to the drawings, wherein like reference numerals designate corresponding structure throughout the views, and referring in particular to FIG. 1, a pacifier 10 that is constructed according to a preferred embodiment of the invention includes a teat holder 12 having a teat connector 14 on a first side thereof and a display face 16 on a second, opposite side thereof. A teat 18 that is preferably fabricated from a relatively soft elastomeric material such as silicone rubber is securely mounted to the teat connector 14 in a manner that will be described in greater detail below. A pacifier 10 further includes a mouth plate member 20 that is secured to the teat holder 12 and that interlocks with teat 18 in order to ensure that the teat 18 does not become separated from the pacifier 10, as will be described in greater detail below. Mouth plate member 20 is shaped to fit between the lips and gum of an infant or small child and is preferably molded from a plastic material that is durable and dishwasher safe, such as polycarbonate.

As FIG. 1 shows, a plurality of decorative gemstones 26 are mounted to the display face 16 of the teat holder 12. Although the gemstones 26 are decorative, their presence on the pacifier 10 may improve the utilitarian function of the pacifier 10, such as by increasing the attention that an infant or small child will pay to the pacifier 10. As will be seen in the discussion of the various exemplary gemstone patterns that is provided below, the presence of the gemstones 26 may also serve an important educational or developmental and function. The eye-catching nature of the gemstones potentially can enhance those developmental benefits by prolonging the attention span of the infant or small child.

The American Academy of Pediatrics (AAP) recommends using a pacifier at nap and nighttime during an infant's first year to help reduce the risk of Sudden Infant Death Syndrome (SIDS). Further information and guidelines on these recommendations are provided at www.aap.org and www.firstcandle.org. Because the pacifier 10 appears to resemble jewelry, it may attract and hold the interest both of infants and caregivers more frequently and for a longer period of time than a conventional pacifier. This may encourage pacifier use, both at home and when traveling, which in turn may help reduce the risk of SIDS.

According to one particularly advantageous feature of the invention, a protective cover 22 is mounted to the teat holder 12 so as to prevent infants, small children and consumers from touching the gemstones 26. The protective cover 22 is preferably constructed so that the gemstones 26 will be visible to infants, small children and consumers when the pacifier 10 is not being used. When the pacifier 10 is being used, the gemstones 26 ordinarily will not be visible to the infant or small child who has the pacifier 10 in his or her mouth. However, the gemstones 26 still typically will be viewable by others when the pacifier 10 is being used, unless a caregiver or other person is in the process of attempting to grip the handle 24 of the pacifier 10 or the protective cover 22 of the pacifier 10 to remove the pacifier 10 from the mouth of the infant or small child.

Another benefit of the protective cover 22 is that it permits a wide assortment of decorative materials that would otherwise be too fragile for use on a pacifier to be used in the creation of a decorative pattern beneath the protective cover 22. For example, glitter material, which may be a vacuum metalized plastic material, could be used in conjunction with gemstones in the preferred embodiments of the invention.

In the preferred embodiment, display face 16 preferably has a plurality of cavities 28 molded therein, and each of the cavities 28 is preferably sized and shaped appropriately for receiving an individual gemstone 26 for seating therein. Each of the plurality of gemstones 26 is respectively then preferably securely seated and adhesively fastened within one of the individual cavities 28 that are provided within the display face 16 of the teat holder 12. The array of cavities 28 on the display face 16 is preferably customized for the particular gemstone design that is to be shown. This customization is effective not only by varying the location and spacing of the individual cavities on the display face 16 but also by varying the size and depth of the individual cavities. By varying the size of the individual cavities, gemstones of different diameters can be used in the design. By varying the depth of the individual cavities, gemstones of different depths can be used in the design. Moreover, by varying the depths of the individual cavities, gemstones having the same depths can be used in a manner to create a design pattern that is non-uniform in height.

Each of the gemstones 26 may be a genuine gemstone, but it is preferably a gemstone simulant, such as a rhinestone. A rhinestone or paste is a diamond simulant made from rock crystal, glass, acrylic or other suitable material. For purposes of this document, the term “gemstone” shall be interpreted as including both genuine gemstones and gemstone simulants such as diamond simulants, e.g. rhinestones.

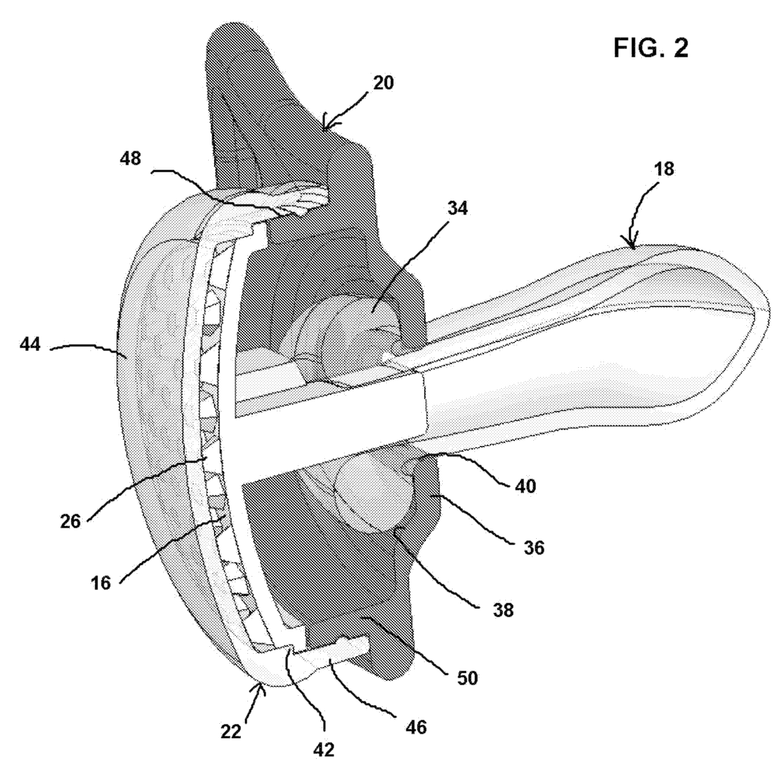

FIG. 2 is an isometric cross-sectional view of a pacifier 10 shown without the handle 24 in an assembled condition. As FIGS. 1 and 2 both show, teat 18 includes an open end 30 that is in communication with an internal space or lumen 32. A retaining end flange 34 is provided adjacent to the open end 30. As is best shown in FIG. 2, the teat connector 14 of the teat holder 12 penetrates the open end 30 of the teat 18, and both the teat connector 14 and the shaft of the teat 18 extend through an opening 40 that is defined in a side wall 36 of the mouth plate member 20. The end flange 34 of the teat 18 is seated within an annular socket 38 that is defined within an inner surface of the side wall 36. The side wall 36 of the mouth plate member 20 thus functions as an interlock to prevent the teat 18 from becoming separated from the pacifier 10.

The protective cover 22 is preferably fabricated from a transparent material, which could be clear or tinted, but is preferably clear. The transparent material could be glass or a plastic material, but is preferably a durable dishwasher safe plastic material such as polycarbonate. Protective cover 22 includes a viewing surface or lens 44 that is constructed and arranged to provide an unobstructed view of the display face 16 and the gemstones 26. Lens 44 preferably has a convex outer surface and is optically neutral. In alternative embodiments, lens 44 could be constructed to be optically active so as to provide magnification of the display face 16 and the gemstones 26, or to provide other optical effects. Lens 44 could also alternatively be mounted so as to be rotatable and be made optically active so as to provide kaleidoscopic effects. Lens surface 44 may have a nonreflective coating provided thereon to reduce glare and improve the appearance of the pacifier 10 in certain light conditions.

The exterior of protective cover 22, including the viewing surface 44 is preferably constructed so as to be substantially smooth and free from small crevices in which bioactive material such as saliva and bits of dried milk and food could potentially collect. A small crevice for purposes of this document is hereby defined as a concave radius of curvature less than 0.05 inches.

Protective cover 22 is also preferably permanently mounted to the teat holder 12, whereby consumers will not be able to gain access to the gemstones 26 without destroying the pacifier 10. In the preferred embodiment, this is achieved by effecting a weld 42 between a sidewall 46 of the protective cover 22 and a circumferential outer surface 47 of the teat holder 12. Weld 42 is preferably but not necessarily a sonic weld. A weld is also preferably formed between the sidewall 46 of the protective cover 42 and a mounting flange 50 of the mouth plate member 20, as is best shown in FIG. 2 to prevent separation of the protective cover 22 from the mouth plate member 20 during use.

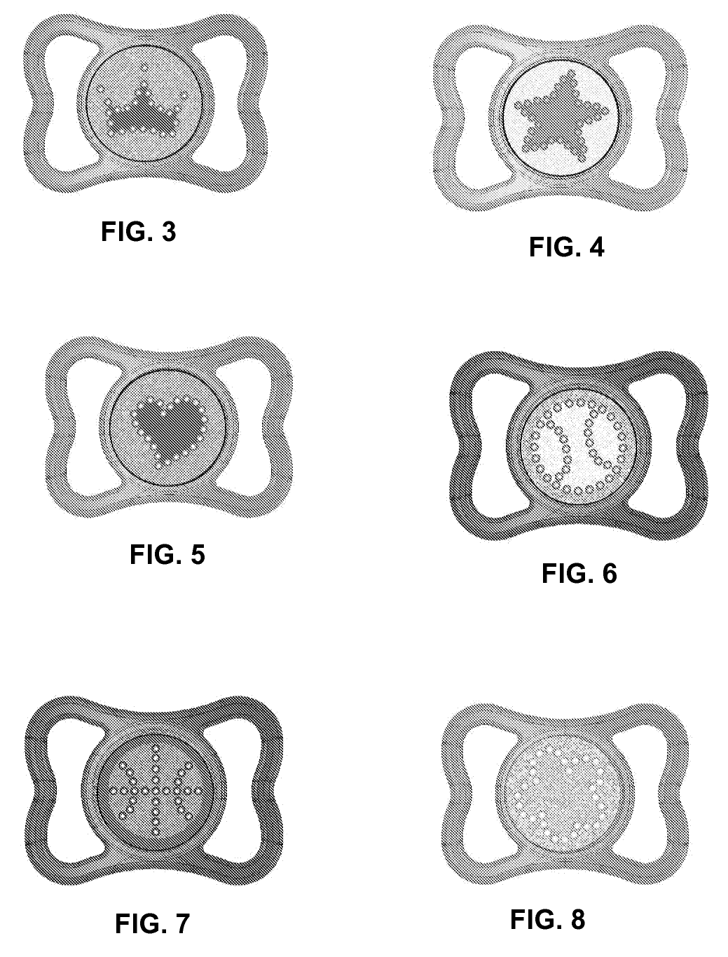

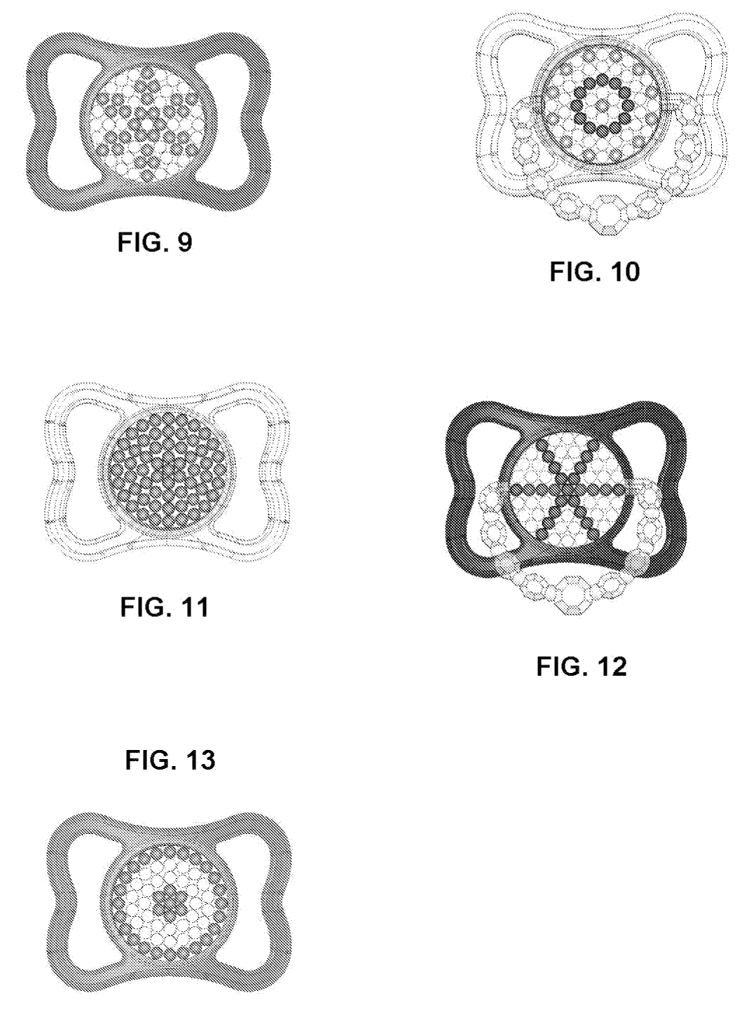

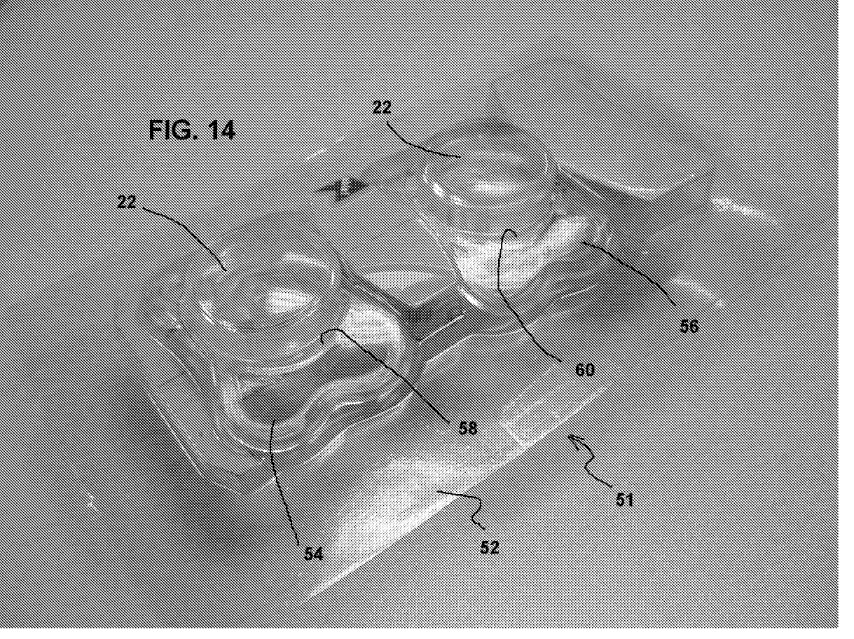

According to one particularly advantageous feature of the invention, the gemstones 26 are preferably of more than one color and may be arranged in discrete patterns according to color. FIGS. 3-13 show pacifiers 10 that are constructed according to the preferred embodiment of the invention and that are provided with different examples of gemstone patterns. In FIGS. 3-8, glitter material is also used to heighten the design effect. In FIG. 3, red and white gemstones are used to create a pattern that is suggestive of a crown. In FIG. 4, orange and yellow gemstones are used to create a pattern that is suggestive of a star. In both FIGS. 3 and 4, gemstones having more than one size are used as well. In FIG. 5, red and white gemstones of different sizes are used to create a pattern that is suggestive of a valentine heart. In FIG. 6, blue, orange and white gemstones of different sizes are used to create a pattern that is suggestive of a baseball. In FIG. 7, orange and white gemstones of different sizes are used to create a pattern that is suggestive of a basketball. In FIG. 8, yellow, green, red and white gemstones of different sizes are used to create a snowflake pattern. Other geometric patterns are shown in FIGS. 9-13.

FIG. 14 depicts a retail packaging unit 51 that is constructed according to a preferred embodiment of the invention. Packaging unit 51 is embodied as a blister pack 52 encasing a first pacifier 54 and a second pacifier 56 that are constructed according to the invention. Both the first and second pacifiers 54, 56 have a protective cover 22 as has been described above that enables a consumer to view a display face 16 having a gemstone pattern thereon. As FIG. 14 shows, the blister pack 52 is constructed with holes 58, 60 that permit the ends of the protective covers 22 to protrude through the blister pack material, whereby the consumer is permitted to have an unobstructed view of the exterior of the lens 44 of the protective cover 22 and accordingly of the gemstone pattern that is provided on the pacifier 54, 56.

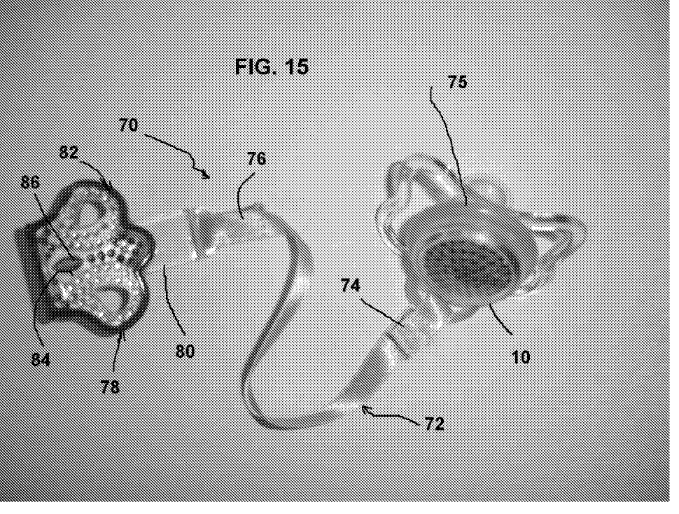

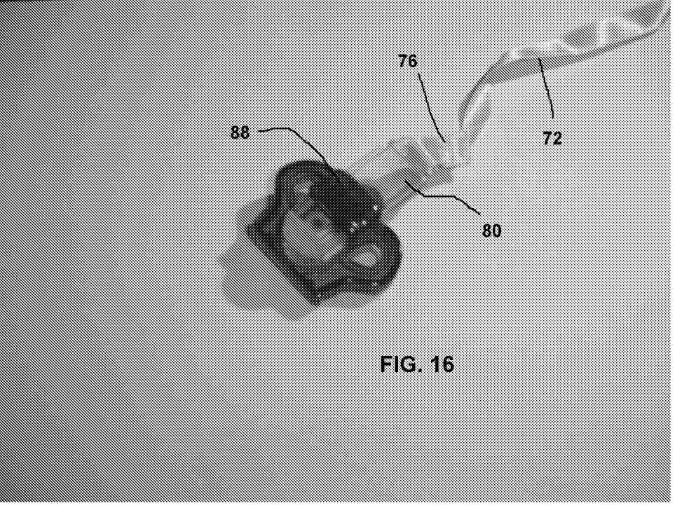

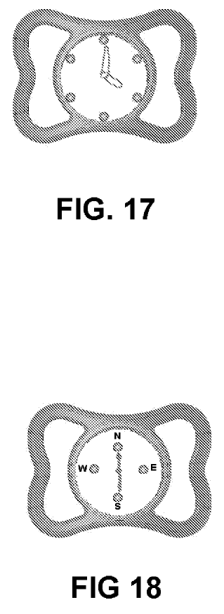

Referring now to FIG. 15 and FIG. 16, a pacifier 10 that is constructed according to the preferred embodiment of the invention may selectively be provided as part of a pacifier assembly 70 including a leash or tether 72 having a first looped end 74 that is releasably secured to a looped portion of a resilient tether ring 75 that is frictionally engaged on to the pacifier 10. Leash 72 has a second looped end 76 at a second end thereof that is opposite to the first end on which the first looped 74 is provided. Both the first and second looped ends 74, 76 are preferably releasable and are preferably fabricated from a hook and loop type fastener such as that which is commonly known under the trade name VELCRO. The second looped end 76 is preferably secured to a decorative clip member 78 that has a clip portion 80 and a decorative body portion 82, as is best shown in FIG. 15. The decorative body portion 82 includes a transparent cover 84, and a decorative pattern of gemstones 86 is embedded into the decorative body portion 82 beneath the transparent cover 84. Preferably, the details of construction of the decorative body portion 82 as far as how the gemstones 86 are placed into the decorative body portion 82 are identical to those described above with reference to the preferred embodiment of the pacifier 10. In other words, the decorative body portion 82 has a surface beneath the transparent cover 84 that has a plurality of cavities molded therein, and each of the cavities is preferably sized and shaped appropriately for receiving an individual gemstone 86 for seating therein. Each of the plurality of gemstones 86 is respectively then preferably securely seated and adhesively fastened within one of the individual cavities 86 that are provided within the decorative body portion beneath the transparent cover 84.

As FIG. 16 shows, clip portion 80 is preferably provided with a sliding locking member 88 to permit a parent or caregiver to secure the clip portion 80 in a closed position. This will prevent the pacifier assembly 70 from falling off the article to which it has been clipped.

As FIGS. 17 and 18 show, a pacifier according to the invention may be provided with a design in which the gemstones are part of a functional device or are part of a design that is intended to be reminiscent of a functional device. In FIG. 17 the pacifier design is that of a watch or clock, with the gemstones being located in positions representing various hours of the day. The pacifier shown in FIG. 17 may be a functioning watch or it may simply be a nonfunctioning decorative watch that is designed to attract interest on the part of an infant or small child in learning how to tell time. FIG. 18 shows a pacifier that is styled as a directional compass, with gemstones being indicative of the primary directions, namely North, South, East and West. The pacifier depicted in FIG. 18 may be an actual functioning compass, or it may be a nonfunctioning decorative compass that is designed to attract interest on the part of an infant or small child in learning how to navigate or tell direction.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A pacifier, comprising:
a teat;
a main body assembly secured to said teat;
a plurality of gemstones; and
a protective cover, said protective cover being mounted to said main body assembly so as to prevent infants, small children and consumers from touching said gemstones, said protective cover further being constructed and said gemstones being positioned so that said gemstones may be visible to infants, small children and consumers through said protective cover.

2. A pacifier according to claim 1, wherein said gemstones comprise at least one gemstone simulant.

3. A pacifier according to claim 2, wherein said gemstone simulant comprises at least one rhinestone.

4. A pacifier according to claim 1, wherein said protective cover is fabricated from a transparent material.

5. A pacifier according to claim 4, wherein said transparent material comprises a transparent plastic material.

6. A pacifier according to claim 1, wherein said transparent plastic material comprises a polycarbonate plastic.

7. A pacifier according to claim 1, wherein said protective cover is permanently mounted to said main body assembly.

8. A pacifier according to claim 7, wherein said protective cover is welded to said main body assembly.

9. A pacifier according to claim 1, wherein said protective cover has an anti-reflective coating thereon.

10. A pacifier according to claim 1, wherein said main body portion has a plurality of cavities defined therein, and wherein said plurality of gemstones are, respectively, seated in said cavities.

11. A pacifier according to claim 1, wherein said protective cover has an outer surface, and wherein said outer surface is free from small crevices in which debris could collect and bacteria could propagate.

12. A pacifier according to claim 11, wherein said outer surface of said protective cover is a substantially smooth surface.

13. A pacifier according to claim 12, wherein said substantially smooth surface is convex.

14. A pacifier according to claim 1, wherein said plurality of gemstones comprise gemstones having more than one color.

15. A pacifier according to claim 14, wherein said gemstones are arranged in a discrete pattern according to color.

16. A pacifier according to claim 1, wherein said gemstones are arranged in a design, and wherein said design further includes glitter material.

17. A pacifier according to claim 1, wherein said gemstones are arranged in a design, and wherein said design is reminiscent of a functional device.

18. A pacifier according to claim 17, wherein said functional device is a watch.

19. A pacifier according to claim 17, wherein said functional device is a compass.

20. A pacifier component, comprising:
a teat connector that is constructed and arranged to have an elastomeric teat mounted thereto; and
a display face, said display face having a plurality of cavities defined therein, each of said cavities being sized and shaped to receive an individual gemstone for seating therein.

21. A pacifier component according to claim 20, further comprising a plurality of gemstones that are respectively seated in said respective cavities.

22. A pacifier component according to claim 21, wherein said gemstones comprise at least one gemstone simulant.

23. A pacifier display assembly, comprising:
a display face, said display face having a plurality of cavities defined therein, each of said cavities being sized and shaped to receive an individual gemstone for seating therein, said display face further being adapted for connection to a main body assembly of a pacifier;
a plurality of gemstones, each of said gemstones respectively being seated in one of said cavities; and
a protective cover that is constructed and arranged to prevent infants, small children and consumers from touching said gemstones while permitting said gemstones to be viewed therethrough.

24. A pacifier display assembly according to claim 23, wherein said gemstones comprise at least one gemstone simulant.

25. A pacifier display assembly according to claim 24, wherein said gemstone simulant comprises at least one rhinestone.

26. A pacifier display assembly according to claim 23, wherein said protective cover is fabricated from a transparent material.

27. A pacifier display assembly according to claim 23, wherein said protective cover is non-removable.

28. A pacifier display assembly according to claim 23, wherein said protective cover has an anti-reflective coating thereon.

29. A pacifier display assembly according to claim 23, wherein said protective cover has an outer surface, and wherein said outer surface is free from small crevices in which debris could collect and bacteria could propagate.

30. A pacifier display assembly according to claim 29, wherein said outer surface of said protective cover is a substantially smooth surface.

31. A pacifier display assembly according to claim 30, wherein said substantially smooth surface is convex.

32. A pacifier display assembly according to claim 23, wherein said plurality of gemstones comprise gemstones having more than one color.

33. A pacifier display assembly according to claim 32, wherein said gemstones are arranged in a discrete pattern according to color.

34. A pacifier display assembly according to claim 23, wherein said gemstones are arranged in a design, and wherein said design further includes glitter material.

35. A pacifier display assembly according to claim 23, wherein said gemstones are arranged in a design, and wherein said design is reminiscent of a functional device.

36. A pacifier display assembly according to claim 35, wherein said functional device is a watch.

37. A pacifier display assembly according to claim 35, wherein said functional device is a compass.

38. A pacifier display assembly according to claim 23, wherein said cavities are varied in size, and wherein said gemstones that are seated within said cavities are respectively also varied in size.

39. A pacifier display assembly according to claim 23, wherein said cavities are varied in depth, and wherein said gemstones that are seated within said cavities are respectively also varied in their height.

38. A pacifier, comprising
a teat holder having a teat connector on a first side thereof and a display face on a second side thereof;
a teat securely mounted to said teat connector;
a plurality of gemstones mounted to said display face;
a mouth plate; and
a protective cover, said protective cover being mounted to said teat holder so as to prevent infants, small children and consumers from touching said gemstones, said protective cover further being constructed so that said gemstones may be visible to infants, small children and consumers therethrough.
